(19) United States
(12) Patent Application Publication
(10) Pub. No.: US 2009/0193092 A1
(43) Pub. Date: Jul. 30, 2009

(54) Method And System For Intercommunicating Chat Information Between Instant Messaging Group And Chat Room As Well As Intercommunication System

(75) Inventor: Linfei Li, Shenzhen City (CN)

Correspondence Address: HARNESS, DICKEY & PIERCE, P.L.C., P.O. BOX 828, BLOOMFIELD HILLS, MI, 48303, US

(73) Assignee: TENCENT TECHNOLOGY (SHENZHEN) COMPANY LIMITED, Shenzhen (CN)

(21) Appl. No.: 12/408,292

(22) Filed: Mar. 20, 2009

Related U.S. Application Data
(63) Continuation of application No. PCT/CN2007/070552, filed on Aug. 24, 2007.

(30) Foreign Application Priority Data
Sep. 22, 2006 (CN) 200610062802.0

(51) Int. Cl. G06F 15/16

(52) U.S. Cl. 709/206

(57) ABSTRACT

The present invention involves Instant Messaging, IM, fields, and provides a system and method for intercommunicating chat information between an IM group and a chat room, and an intercommunication system. The system for intercommunicating chat information between an IM group and a chat room includes an IM group system, a chat room system, and an intercommunication system located between the IM group system and chat room system, the intercommunication system being adapted to establish a connection channel between the IM group system and the chat room system and forward chat information between the IM group system and the chat room system according to the connection channel. By adding an intercommunication system between the IM group system and chat room system to manage connections and forward information for the two parties, the intercommunication between the IM group system and chat room system can be implemented effectively with low costs.

### CROSS-REFERENCE TO RELATED APPLICATIONS

This application is a continuation of International Application No. PCT/CN2007/070552, filed Aug. 24, 2007. This application claims the benefit and priority of Chinese Application No. 200610062802.0, filed Sep. 22, 2006. The entire disclosures of each of the above applications are incorporated herein by reference.

### FIELD

The present disclosure relates to the field of Instant Messaging, and particularly relates to a method and system for intercommunicating chat information between an Instant Messaging (IM) group and a chat room, and the present invention further relates to an intercommunication system.

### BACKGROUND

This section provides background information related to the present disclosure which is not necessarily prior art.

With the development of network technology, Instant Messaging (IM) has become the most popular way of network communications for network users. Besides one-to-one communications, IM can further provide a discussion among multiple users in an IM group or a chat room at present.

The existing IM group system provides an effective communication platform for users in a group and is responsible for organizing and managing the users thereof. However, IM groups claim strict identity authentication for users, so that a users not belonging to an IM group can neither send/receive chat information in the IM group nor join a discussion of a topic in the IM group. In contrast, in a chat room system, a user can communicate with more than one user without identity authentication (e.g., anonymous logon), where, it is inconvenient for managing a chat room since users thereof is variable. So far, the above-mentioned two instant messaging systems are totally independent, so manual transferring operations have to be implemented if a user of an IM group desires to communicate within a larger user-group or if a user not belonging to an IM group, e.g., a chat room user, desires to participate in a discussion of a topic in the IM group.

### SUMMARY

This section provides a general summary of the disclosure, and is not a comprehensive disclosure of its full scope or all of its features.

In accordance with an embodiment of the present invention, a system for intercommunicating chat information between an IM group and a chat room, includes an IM group system and a chat room system, and further includes an intercommunication system adapted to establish a connection channel between the IM group system and the chat room system and forwarding chat information between the IM group system and the chat room system through the connection channel.

In accordance with an embodiment of the present invention, a method for intercommunicating chat information between an IM group and a chat room includes the following steps: when any party of an IM group system and a chat room system initiates a connection request for intercommunicating with the other party, establishing a connection channel between the IM group system and the chat room system according to the connection request; and, forwarding chat information between the IM group system and the chat room system through the connection channel.

Embodiments of the present invention also provide an intercommunication system for intercommunicating chat information between an IM group and a chat room. The said intercommunication system includes a connection managing module and an information forwarding module, wherein, the connection managing module is adapted to establish a connection channel between the IM group system and the chat room system according to a connection request initiated by any party of the IM group system and the chat room system; and, the information forwarding module is adapted to forward chat information between the IM group system and the chat room system through the connection channel.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram illustrating a structure of a system for intercommunicating chat information between an IM group and a chat room in accordance with an embodiment of the present invention; and,

FIG. 2 is a flowchart illustrating a flow chart of a method for intercommunicating chat information between an IM group and a chat room in accordance with an embodiment of the present invention.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

In order to make objects, technical schemes and advantages of the present invention clearer, the present invention will be further described in detail hereinafter with reference to the drawings and embodiments. It should be understood that, the described embodiments hereinafter are used only to describe the present invention, while not to limit the present invention.

Inventor of the present invention finds that, the implementation of the manual transferring operations will consequentially lead to high costs, and the manual transferring operations, being without enough practical application, are unable to satisfy the above-mentioned desires of instant messaging users effectively.

Therefore, a solution is needed to effectively implement intercommunicating chat information between an IM group and a chat room with low costs.

In the embodiments of the present invention, an intercommunication system is added between an IM group system and a chat room system, which is for managing connections (including establishing or disconnecting a connection channel) and forwarding information between the two systems, so that the chat information can be intercommunicated between an IM group and a chat room.

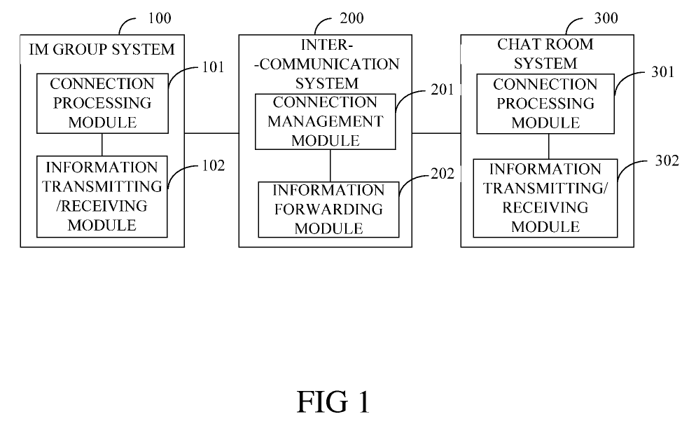

FIG. 1 shows a structure of a system for intercommunicating chat information between an IM group and a chat room in accordance with an embodiment of the present invention. The system involves IM group system 100, chat room system 300 and intercommunication system 200 configured between IM group system 100 and chat room system 300.

Wherein, IM group system 100 includes connection processing module 101 and information transmitting/receiving module 102. Connection processing module 101 is adapted for initiating a connection request for intercommunicating with chat room system 300, and/or, is adapted for authenticating a connection request initiated by chat room system 300. Information transmitting/receiving module 102 is adapted for automatically packing chat information of an IM group and transmitting the packed chat information to chat room system 300 in real time during an instant messaging procedure, and/or, is adapted for receiving chat information from chat room system 300 and displaying the received chat information. Information transmitting/receiving module 102 may be an information transmitting/receiving interface or information transceiver.

In accordance with IM group system 100, chat room system 300 includes connection processing module 301 and information transmitting/receiving module 302. Wherein, connection processing module 301 is adapted for initiating a connection request for intercommunicating with IM group system 100, and/or, is adapted for authenticating the connection request initiated by IM group system 100. It should be noted that, in practical application, the present invention does not restrict the initiator of the connection request, and any party of IM group system 100 and chat room system 300 may initiate the connection request, where the connection request may be authenticated by the other party, and the connection request may alternatively be accepted by the other party directly without authentication if security is not highly required. In addition, there may be multiple ways for initiating the connection request. For example, a user in an IM group or a chat room may be authorized to initiate the connection request. And, information transmitting/receiving module 302 is adapted for automatically packing chat information of chat room system 300 and transmitting the packed chat information to IM group system 100 in real time during an instant messaging procedure, and/or, is adapted for receiving chat information from IM group system 100 and displaying the received chat information. Information transmitting/receiving module 302 may be an information transmitting/receiving interface or information transceiver.

Intercommunication system 200 includes connection managing module 201 and information forwarding module 202.

Wherein, connection managing module 201 is mainly adapted for establishing a connection channel between IM group system 100 and chat room system 300 as well as disconnecting the connection channel. For instance, after receiving a connection request initiated by any party of IM group system 100 and chat room system 300, connection managing module 201 initializes the received connection request at first, and then sends the connection request to the other party. After the other party has authenticated the connection request and returned a message indicating the two parties having been connected successfully, connection managing module 201 establishes a forwarding service according to the message indicating the two parties having been connected successfully, and then establishes a connection channel between IM group system 100 and chat room system 300. When any party of IM group system 100 and chat room system 300 initiates a request of disconnecting the connection between the two parties, connection managing module 201 disconnects the previously-established connection channel based on a mechanism the same as the above-mentioned processes.

Information forwarding module 202 is mainly adapted for forwarding chat information of one party of IM group system 100 and chat room system 300 to the other party during an instant messaging procedure. For example, after receiving a data packet of chat information sent automatically by any party of IM group system 100 and chat room system 300 in real time, information forwarding module 202 first adjusts the attributes of the data packet to make them in accord with those of the data packet acceptable by the other party, where the attributes adjusted may include the size, fragment, analyzing privilege and identifier of the data packet and so on, so as to implement conversion between message protocols of the two instant messaging systems, and only when the attributes of the data packet have met requirements of the receiver, can the data packet be received by the receiver with its contents being identified by the receiver. A data packet is sent to the receiver when the attributes of the data packet are adjusted to be in accord with those of the data packet acceptable by the receiver, namely, the other party of IM group system 100 and chat room system 300. Of course, when IM group system 100 and chat room system 300 adopt the same message protocol, information forwarding module 202 may forward the received data packet directly without adjusting its attributes.

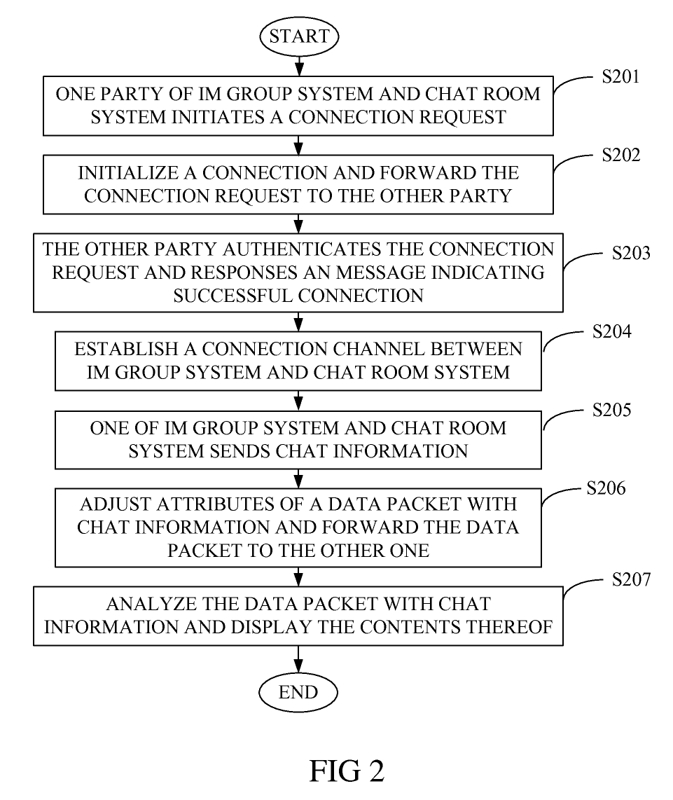

FIG. 2 is a flowchart illustrating a flow chart of a method for intercommunicating chat information between an IM group and a chat room in accordance with an embodiment of the present invention, which includes the following steps.

In step S201, any party of IM group system 100 and chat room system 300 initiates a connection request for intercommunicating with the other party, and there may be multiple ways for initiating such a request. For instance, an authorized user (like an administrator) in IM group system 100 or chat room system 300 initiates a connection request through connection processing module 101 or 301. And the connection request is firstly sent to connection managing module 201 in intercommunication system 200.

In step S202, connection managing module 201 in intercommunication system 200 initializes a connection according to the connection request first, and then sends the connection request to the other party of IM group system 100 or chat room system 300. The initialization herein includes authenticating the authority of the party initiating the connection request as well as the other party to be connected, e.g., authenticating whether the IM user initiating the connection request has the authority and whether the chat room to be connected is available for connection. In some cases such as security not highly required, connection managing module 201 may directly send the connection request to the other party of IM group system 100 and chat room system 300 without the above initialization.

In step S203, after receiving the connection request, connection processing module of the other party of IM group system 100 and chat room system 300 authenticates the connection request, including authenticating validity of the connection request and etc., and then returns a message indicating the two parties having been connected successfully to connection managing module 201 in intercommunication system 200 after the request is successfully authenticated.

In step S204, connection managing module 201 in intercommunication system 200 establishes a forwarding service after receiving the message indicating the two parties having been connected successfully, and forwards the message indicating the two parties having been connected successfully to the initiator of the connection request so as to establish a connection channel between IM group system 100 and chat room system 300 which may be denoted as “IM group system 100—intercommunication system 200—chat room system 300”. The connection is successfully established so far, and chat information can be intercommunicated, where, users of an IM group and users of a chat room can conveniently transmit or receive information at their own system's interfaces, and thus information forwarding is performed by intercommunication system 200 without manually transferring between the two parties' systems.

In step S205, through information transmitting/receiving module (like information transmitting/receiving module 102 in IM group system 100 or information transmitting/receiving module 302 in chat room system 300), any party of IM group system 100 and chat room system 300 automatically packs the chat information in local system during an instant messaging procedure and sends the packed chat information to information forwarding module 202 in intercommunication system 200 in real time. For example, typically, while chat information sent by a user of an IM group is presented in the IM group, the chat information can be automatically received by information transmitting/receiving module 102 in IM group system 100 in real time and can be transmitted to information forwarding module 202 in intercommunication system 200 for subsequent forwarding.

In step S206, after receiving a data packet containing the chat information, information forwarding module 202 in intercommunication system 200 adjusts attributes of the data packet to make them in accord with those of the data packet acceptable by the other party, where the attributes adjusted may include the size, fragment, analyzing privilege and identifier of the data packet and so on, so as to implement conversion between message protocols of the two instant messaging systems, and only when the attributes of the data packet have met requirements of the receiver, can the data packet be received by the receiver with its contents being identified by the receiver. A data packet is sent to the receiver when the attributes of the data packet are adjusted to be in accord with those of the data packet acceptable by the receiver, namely, the other party of IM group system 100 and chat room system 300.

In step S207, after receiving the data packet containing the chat information with adjusted attributes, the receiver (i.e., IM group system 100 or chat room system 300) analyzes the data packet to get its contents (i.e., the chat information contained in the data packet) and display the contents on the local system's chat interface. So far, a complete procedure of chat information intercommunication is finished successfully.

In accordance with the embodiments of the present invention, after all the steps mentioned above, if any party of IM group system 100 and chat room system 300 initiates a disconnection request, the disconnection request is then forwarded to the other party to cut the connection channel, and the forwarding service is stopped. Such disconnection procedure will be illustrated hereinafter with reference to a case of a user of an IM group initiating a disconnection request. When the user of the IM group initiates a disconnection request, connection processing module 101 in IM group system 100 sends the disconnection request to connection managing module 201 in intercommunication system 200. After receiving the disconnection request from IM group system 100, connection managing module 201 further sends the disconnection request to connection managing module 301 in chat room system 300. After receiving the disconnection request, connection managing module 301 cuts the corresponding connection, i.e., releases the port adapted for the connection in chat room system 300, and returns a message indicating the connection between the two parties having been disconnected successfully to connection managing module 201 in intercommunication system 200. And then, connection managing module 201 stops the forwarding service of information forwarding module 202, and returns a feedback to connection processing module 101 in IM group system 100. Finally, connection processing module 101 cuts the corresponding connection, namely, releases the port adapted for the connection in IM group system 100. And otherwise, if a disconnection request is initiated by a user of a chat room, the disconnection procedure is implemented in a reverse way of the above-mentioned procedure regarding a user of an IM group initiating a disconnection request, which is not to be illustrated hereby.

It is remarkable that intercommunication system 200 is easy to implement and does not need much costs and thus makes the implementation of the intercommunication between the two types of instant messaging both effective and economical.

In addition, intercommunication system 200 may exist independently of IM group system 100 and chat room system 300, or may be integrated in any one of IM group system 100 and chat room system 300, the location of which may change according to specific situations in practical application.

By adding an intercommunication system between the IM group system and the chat room system to manage connections and forward information between the two systems, the embodiments of the present invention are able to implement effective and low-cost intercommunication between the IM group system and the chat room, and thus improve the variety of the instant messaging communications.

The above illustration is just preferable embodiments of the present invention and not used to confine the present invention. Any modification, equivalent substitute and improvement within principle of the present invention shall be in the protection scope of the present invention.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A system for intercommunicating chat information between an Instant Messaging, IM, group and a chat room, comprising an IM group system, a chat room system, and an intercommunication system, wherein,
the intercommunication system is adapted to establish a connection channel between the IM group system and the chat room system and forward chat information between the IM group system and the chat room system through the connection channel.

2. The system for intercommunicating chat information between an IM group and a chat room according to claim 1, wherein, the intercommunication system is further adapted to disconnect the connection channel between the IM group system and the chat room system and stop forwarding the chat information.

3. The system for intercommunicating chat information between an IM group and a chat room according to claim 1, wherein, the intercommunication system is located in the IM group system or the chat room system, or is located between the IM group system and the chat room system.

4. The system for intercommunicating chat information between an IM group and a chat room according to claim 2, wherein, the intercommunication system is located in the IM group system or the chat room system, or is located between the IM group system and the chat room system.

5. The system for intercommunicating chat information between an IM group and a chat room according to claim 1, wherein, each of the IM group system and the chat room system comprises a connection processing module and an information transmitting/receiving module, wherein,
the connection processing module is adapted to send a connection request to the intercommunication system, and/or, is adapted to process a connection request forwarded by the intercommunication system to establish the connection channel; and,
the information transmitting/receiving module is adapted to send chat information of the system where it is located to the intercommunication system, and/or, is adapted to receive chat information forwarded by the intercommunication system and display the received chat information.

6. The system for intercommunicating chat information between an IM group and a chat room according to claim 5, wherein, the connection processing module is further adapted to send a disconnection request to the intercommunication system, and/or, is further adapted to receive a disconnection request forwarded by the intercommunication system and disconnect the connection channel.

7. A method for intercommunicating chat information between an IM group and a chat room, comprising:
when any party of an IM group system and a chat room system initiates a connection request for intercommunicating with the other party, establishing a connection channel between the IM group system and the chat room system according to the connection request; and,
forwarding chat information between the IM group system and the chat room system through the connection channel.

8. The method for intercommunicating chat information between an IM group and a chat room according to claim 7, wherein, the establishing the connection channel between the IM group system and the chat room system comprises:
initializing a connection according to the connection request and sending the connection request to the other party of the IM group system and the chat room system;
by the other party of the IM group system and the chat room system, authenticating the connection request after receiving the connection request and returning a message indicating the two parties being connected successfully after the connection request is authenticated successfully; and,
establishing a forwarding service according to the message indicating the two parties being connected successfully to establish a connection channel between the IM group system and the chat room system for intercommunicating the chat information.

9. The method for intercommunicating chat information between an IM group and a chat room according to claim 8, wherein, the authenticating comprises authenticating validity of the connection request.

10. The method for intercommunicating chat information between an IM group and a chat room according to claim 7, wherein, the forwarding chat information between the IM group system and the chat room system through the connection channel comprises:
transmitting, by one party of the IM group system and the chat room system, its own chat information in a data packet;
adjusting attributes of the data packet with the chat information to make the data packet acceptable by the other party of the IM group system and the chat room system and forwarding the data packet to the other party of the IM group system and the chat room system; and,
by the other party of the IM group system and the chat room system, analyzing the data packet with the chat information and displaying contents of the chat information in local system after receiving the data packet.

11. The method for intercommunicating chat information between an IM group and a chat room according to any of claim 7, further comprising:
disconnecting the connection channel between the IM group system and the chat room system and stop forwarding the chat information according to a disconnect request initiated by any party of the IM group system and the chat room system.

12. The method for intercommunicating chat information between an IM group and a chat room according to any of claim 8, further comprising:
disconnecting the connection channel between the IM group system and the chat room system and stop forwarding the chat information according to a disconnect request initiated by any party of the IM group system and the chat room system.

13. The method for intercommunicating chat information between an IM group and a chat room according to any of claim 9, further comprising:
disconnecting the connection channel between the IM group system and the chat room system and stop forwarding the chat information according to a disconnect request initiated by any party of the IM group system and the chat room system.

14. The method for intercommunicating chat information between an IM group and a chat room according to any of claim 10, further comprising:
disconnecting the connection channel between the IM group system and the chat room system and stop forwarding the chat information according to a disconnect request initiated by any party of the IM group system and the chat room system.

15. An intercommunication system for intercommunicating chat information between an IM group and a chat room, wherein, the intercommunication system comprises a connection managing module and an information forwarding module, wherein:
the connection managing module is adapted to establish a connection channel between the IM group system and the chat room system according to a connection request initiated by any party of the IM group system and the chat room system; and,
the information forwarding module is adapted to forward chat information between the IM group system and the chat room system through the connection channel.

16. The intercommunication system for intercommunicating chat information between an IM group and a chat room according to claim 15, wherein, the connection managing module is further adapted to disconnect the connection channel according to the disconnection request initiated by any party of the IM group system and the chat room system and stop the forwarding the chat information of the information forwarding module.

17. The intercommunication system for intercommunicating chat information between an IM group and a chat room according to claim 15, wherein,
the information forwarding module is adapted to adjusting attributes of a data packet with chat information transmitted from one party of the IM group system and the chat room system to make the data packet acceptable by the other party of the IM group system and the chat room system and forward the data packet to the other party of the IM group system and the chat room system.

18. The intercommunication system for intercommunicating chat information between an IM group and a chat room according to claim 15, wherein,
the connection managing module is adapted to initialize a connection according to the connection request initiated by one party of the IM group system and the chat room system, send the connection request to the other party, and establish a forwarding service if receiving a message indicating the two parties being connected successfully from the other party to establish a connection channel between the two parties for intercommunicating the chat information.
